(19) United States
(12) Patent Application Publication
(10) Pub. No.: US 2010/0040146 A1
(43) Pub. Date: Feb. 18, 2010

(54) Method and apparatus for multiple pass video coding and decoding

(76) Inventors: Beibei Wang, Bensalem, PA (US); Peng Yin, West Windsor, NJ (US)

Correspondence Address: Robert D. Shedd, Patent Operations;THOMSON Licensing LLC, P.O. Box 5312, Princeton, NJ, 08543-5312, US

(21) Appl. No.: 12/310,757

(22) PCT Filed: Feb. 15, 2007
(86) PCT No.: PCT/US2007/004110

§ 371 Date: Mar. 6, 2009

(30) Foreign Application Priority Data
Sep. 22, 2006 (US) PCT/US2006/037139

(51) Int. Cl. H04N 7/26

(52) U.S. Cl. 375/240.16; 375/E07.115

(57) ABSTRACT

There are provided a video encoder, a video decoder and corresponding method for encoding and decoding video signal data using a multiple-pass video encoding scheme. The video encoder includes a motion estimator and a decomposition module. The motion estimator performs motion estimation on the video signal data to obtain a motion residual corresponding to the video signal data in a first encoding pass. The decomposition module, in signal communication with the motion estimator, decomposes the motion residual in a subsequent encoding pass.

### CROSS-REFERENCE TO RELATED APPLICATIONS

This application claims the benefit of PCT International Application. No. PCT/US2006/037139, filed Sep. 22, 2006 and entitled “METHOD AND APPARATUS FOR MULTIPLE PASS VIDEO CODING AND DECODING,” which is incorporated by reference herein in its entirety.

### FIELD OF THE INVENTION

The present invention relates generally to video encoding and decoding and, more particularly, to a method and apparatus for multiple pass video encoding and decoding.

### BACKGROUND OF THE INVENTION

The International Organization for Standardization/International Electrotechnical Commission (ISO/IEC) Moving Picture Experts Group-4 (MPEG-4) Part 10 Advanced Video Coding (AVC) standard/international Telecommunication Union, Telecommunication Sector (ITU-T) H.264 standard (hereinafter the “MPEG4/H.264 standard” or simply the “H.264 standard”) is currently the most powerful and state-of-the-art video coding standard. Like all other video coding standards, the H.264 standard uses block-based motion-compensation and discrete cosine transform (DCT)-like transform coding. It is well-known that DCT is efficient for video coding and suitable for high-end applications, like broadcast high definition television (HDTV). However, the DCT algorithm is not as well suited for applications which require very low bit rates, such as a dedicated video cell phone. At very low bitrates, the DCT transform will introduce blocking artifacts, even with the use of deblocking filters, because very few coefficients can be coded at very low bitrates, and each coefficient tends to have a very coarse quantization step.

Matching pursuit (MP) is a greedy algorithm to decompose any signal into a linear expansion of waveforms that are selected from a redundant dictionary of functions. These waveforms are selected to best match the signal structures.

Suppose we have a 1-D signal f(t), and we want to decompose this signal using basis vectors from an over-complete dictionary set G. Individual dictionary functions can be denoted as follows:

gᵣ[t]∈G (1)

where γ is an indexing parameter associated with a particular dictionary element. The decomposition begins by choosing γ to maximize the absolute value of the inner product as follows:

p= [symbol] f[t],g_{γ}[t] [symbol] (2)

Then the residual signal is computed as follows:

R(t)=f(t)−pg_{γ}(t) (3)

This residual signal is then expanded in the same way as the original signal. The procedure continues iteratively until either a set number of expansion coefficients are generated or some energy threshold for the residual is reached. Each stage n generates a dictionary function γₙ. After a total of M stages, the signal can be approximated by a linear function of the dictionary elements as follows:

$$\hat{f} ( t ) = {\sum }_{n = 1}^{M} {p}_{n} {g}_{{γ}_{n}} ( t ) \qquad ( 4 )$$

The complexity of a Matching Pursuit decomposition of a signal of n samples proves to be of the order k·N·d·n log₂ n. Here d depends on the size of the dictionary without considering translations, N is the number of chosen expansion coefficients, and the constant k depends on the strategy to select the dictionary functions. Given a highly over-complete dictionary, Matching Pursuit is more computationally consuming than 8×8 and 4×4 DCT integer transforms used in the H.264 standard, whose complexity is defined as O(n log₂ n).

In general, the Matching Pursuit algorithm is compatible with any set of redundant basis shapes. It has been proposed to expand a signal using an over-complete basis of Gabor functions. The 2-D Gabor dictionary is extremely redundant, and each shape may exist at any integer-pixel location in the coded residual image. Since Matching Pursuit has a much larger dictionary set and each coded basis function is well-matched to the structures in the residual signal, the frame-based Gabor dictionary does not include an artificial block structure.

The Gabor redundant dictionary set has been adopted for very low bit-rate video coding based on matching pursuits, with respect to a proposed video coding system using a matching pursuit algorithm (hereinafter referred to as the “prior art Gabor-based Matching Pursuit video coding approach”). The proposed system is based on the framework of a low bit rate hybrid-DCT system referred to as Simulation Model for Very Low Bit Rate Image Coding, or “SIM3” in short, where the DCT residual coder is replaced with a Matching Pursuit coder. This coder uses Matching Pursuit to decompose the motion residual images over dictionary separable 2-D Gabor functions. The proposed system was shown to perform well on low motion sequences at low bitrate.

A smooth 16×16 sine-square window has been applied on the predicted images for 8×8 partitions in the prior art Gabor-based Matching Pursuit video coding approach. The Matching Pursuit video codec in the prior art Gabor-based Matching Pursuit Video coding approach is based on the ITU-T H.263 codec. However, the H.264 standard enables variable block-size motion compensation with small block sizes which, for luma motion compensation, may be as small as 4×4. Moreover, the H.264 standard is based primarily on a 4×4 DCT-like transform for baseline and main profile, and not 8×8 as are most other prominent prior video coding standards. The directional spatial prediction for intra coding improves the quality of the prediction signals. All those highlighted design features make the H.264 standard more efficient, but it requires dealing with more complicated situations when applying Matching Pursuit on the H.264 standard. The smooth 16×16 sine-squared window is represented as follows:

$$ω ( i ) = {sin}^{2} ( \frac{π ( i + \frac{1}{2} )}{N} ) \\ W ( i , j ) = ω ( i ) \cdot ω ( j ) , \\ i , j ∈ \{ 0 , 1 , … , N - 1 \} \qquad ( 5 )$$

A hybrid coding scheme (hereinafter the “prior art hybrid coding scheme”) has been proposed that benefits from some of the features introduced by the H.264 standard for motion estimation and replaces the transform in the spatial domain. The prediction error is coded using the Matching Pursuit algorithm, which decomposes the signal over an appositely designed bi-dimensional, anisotropic, redundant dictionary. Moreover, a fast atom search technique was introduced. However, the proposed prior art hybrid coding scheme has not addressed whether or not it uses one-pass or two-pass scheme. Moreover, the proposed prior art hybrid coding scheme disclosed that the motion estimation part is compatible with the H.264 standard, but did not address whether any deblocking filters have been used in the coding scheme or whether any other methods have been used to smooth the blocking artifacts caused by the predicted images at very low bit rate.

### SUMMARY OF THE INVENTION

These and other drawbacks and disadvantages of the prior art are addressed by the present invention, which is directed to a method and apparatus for multiple pass video encoding and decoding.

According to an aspect of the present invention, there is provided a video encoder for encoding video signal data using a multiple-pass video encoding scheme. The video encoder includes a motion estimator and a decomposition module. The motion estimator performs motion estimation on the video signal data to obtain a motion residual corresponding to the video signal data in a first encoding pass. The decomposition module, in signal communication with the motion estimator, decomposes the motion residual in a subsequent encoding pass.

According to another aspect of the present invention, there is provided a method for encoding video signal data using a multiple-pass video encoding scheme. The method includes performing motion estimation on the video signal data to obtain a motion residual corresponding to the video signal data in a first encoding pass, and decomposing the motion residual in a subsequent encoding pass.

According to yet another aspect of the present invention, there is provided a video decoder for decoding a video bitstream. The video decoder includes an entropy decoder, an atom decoder, an inverse transformer, a motion compensator, a deblocking filter, and a combiner. The entropy decoder decodes the video bitstream to obtain a decompressed video bitstream. The atom decoder, in signal communication with the entropy decoder, decodes decompressed atoms corresponding to the decompressed bitstream to obtain decoded atoms. The inverse transformer, in signal communication with the atom decoder, applies an inverse transform to the decoded atoms to form a reconstructed residual image. The motion compensator, in signal communication with the entropy decoder, performs motion compensation using motion vectors corresponding to the decompressed bitstream to form a reconstructed predicted image. The deblocking filter, in signal communication with the motion compensator, performs deblocking filtering on the reconstructed predicted image to smooth the reconstructed predicted image. The combiner, in signal communication with the inverse transformer and the overlapped block motion compensator, combines the reconstructed predicted image and the residue image to obtain a reconstructed image.

According to still another aspect of the present invention, there is provided a method for decoding a video bitstream. The method includes decoding the video bitstream to obtain a decompressed video bitstream, decoding decompressed atoms corresponding to the decompressed bitstream to obtain decoded atoms, applying an inverse transform to the decoded atoms to form a reconstructed residual image, performing motion compensation using motion vectors corresponding to the decompressed bitstream to form a reconstructed predicted image, performing deblocking filtering on the reconstructed predicted image to smooth the reconstructed predicted image, and combining the reconstructed predicted image and the residue image to obtain a reconstructed image.

These and other aspects, features and advantages of the present invention will become apparent from the following detailed description of exemplary embodiments, which is to be read in connection with the accompanying drawings.

### BRIEF DESCRIPTION OF THE DRAWINGS

The present invention may be better understood in accordance with the following exemplary figures, in which:

FIGS. 1A and 1B are diagrams for exemplary first and second pass portions of an encoder in a two-pass H.264 standard-based Matching Pursuit encoder/decoder (CODEC) to which the present principles may be applied according to an embodiment of the present principles;

FIG. 2 is a diagram for an exemplary decoder in a two-pass H.264 standard-based Matching Pursuit encoder/decoder (CODEC) to which the present principles may be applied according to an embodiment of the present principles;

FIG. 3 is a diagram for an exemplary method for encoding an input video sequence in accordance with an embodiment of the present principles; and

FIG. 4 is a diagram for an exemplary method for decoding an input video sequence in accordance with an embodiment of the present principles.

### DETAILED DESCRIPTION

The present invention is directed to a method and apparatus for multiple pass video encoding and decoding. Advantageously, the present invention corrects the blocking artifacts introduced by the DCT transform used in, e.g., the H.264 standard in very low bit rate applications. Moreover, it is to be appreciated that the present invention is not limited to solely low bit rate applications, but may be used for other (higher) bit rates as well, while maintaining the scope of the present invention.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

In accordance with the present principles, a multiple pass video encoding and decoding scheme is provided. The multiple pass video encoding and decoding. scheme may be used with Matching Pursuit. In an illustrative embodiment, a two-pass H.264-based coding scheme is disclosed for Matching Pursuit video coding.

The H.264 standard applies block-based motion compensation and DCT-like transform similar to other video compression standards. At very low bitrates, the DCT transform will introduce blocking artifacts, even with the use of de-blocking filters, because very few coefficients can be coded at very low bitrates, and each coefficient tends to have a very coarse quantization step. In accordance with the present principles, matching pursuit using an over-complete basis is applied to code the residual images. The motion compensation and mode decision parts are compatible with the H.264 standard. The overlapped block motion compensation (OBMC) is applied to smooth the predicted images. In addition, a new approach is provided for selecting a basis other than Matching Pursuit.

In accordance with the present principles, a video encoder and/or decoder applies OBMC on predicted images to reduce the blocking artifacts caused by the prediction models. The Matching Pursuit algorithm is used to code the residual images. The advantage of Matching Pursuit is that it is not block-based, but frame-based, so there are no blocking artifacts caused by the coding residual difference.

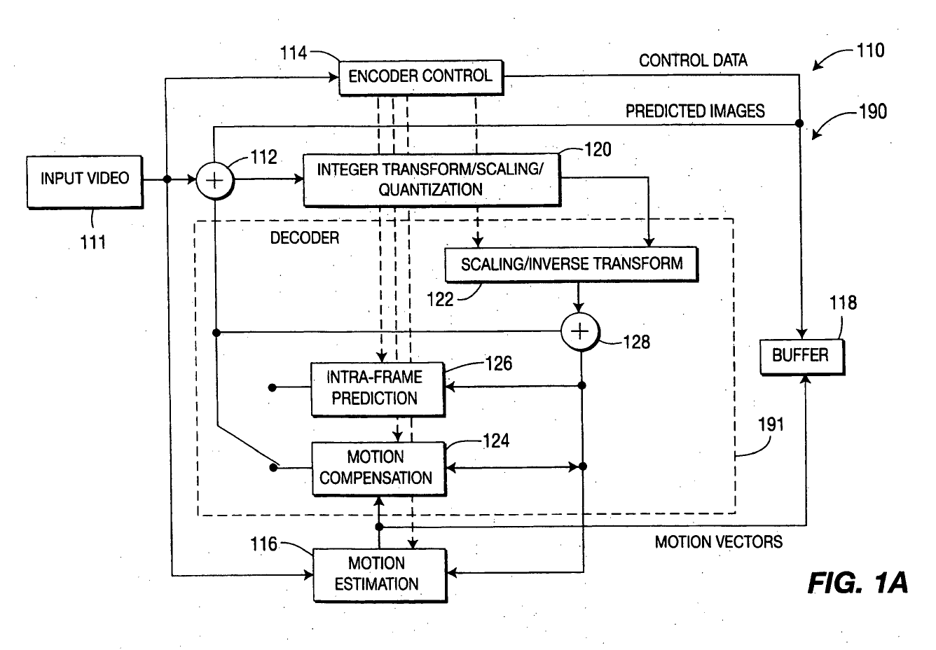

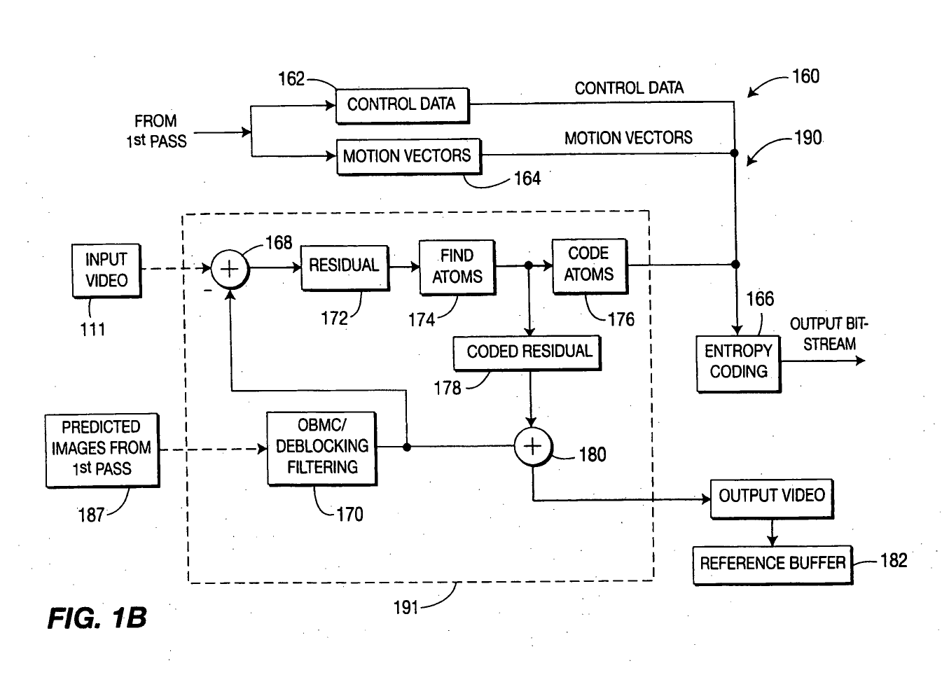

Turning to FIGS. 1A and 1B, exemplary first and second pass portions of an encoder in a two-pass H.264 standard-based Matching Pursuit encoder/decoder (CODEC) are indicated generally by the reference numerals 110 and 160. The encoder is indicated generally by the reference numeral 190 and a decoder portion is indicated generally by the reference numeral 191.

Referring to FIG. 1A, an input of the first pass portion 110 is connected in signal communication with a non-inverting input of a combiner 112, an input of an encoder control module 114, and a first input of a motion estimator 116. A first output of the combiner 112 is connected in signal communication with a first input of a buffer 118. A second output of the combiner 112 is connected in signal communication with an input of an integer transform/scaling/quantization module 120. An output of the integer transform/scaling/quantization module 120 is connected in signal communication with a first input of a scaling/inverse transform module. 122.

A first output of the encoder control module 114 is connected in signal communication with a first input of an intra-frame predictor 126. A second output of the encoder control module 114 is connected in signal communication with a first input of a motion compensator 124. A third output of the encoder control module 114 is connected in signal communication with a second input of the motion estimator 116. A fourth output of the encoder control module 114 is connected in signal communication with a second input of the scaling/inverse transform module 122. A fifth output of the encoder control module 114 is connected in signal communication with the first input of the buffer 118.

An output of the motion estimator 116 is connected in signal communication with a second input of a motion compensator 124 and a second input of the buffer 128. An inverting input of the combiner 112 is selectively connected in signal communication with an output of the motion compensator 124 or an output of an intra-frame predictor 126. The selected output of either the motion compensator 124 or the intra-frame predictor 126 is connected in signal communication with a first input of a combiner 128. An output of the scaling/inverse transform module 122 is connected in signal communication with a second input of the combiner 128. An output of the combiner 128 is connected in signal communication with a second input of the intra-frame predictor 126, a third input of the motion estimator 116, and an input/output of the motion compensator 124. An output of the buffer 118 is available as an output of the first pass portion 110.

With respect to the first pass portion 110, the encoder control module 114, the integer transform/scaling/quantization module 120, the buffer 118, and the motion estimator 116 are included in the encoder 190. Moreover, with respect to the first pass portion, the scaling/inverse transform module 122, the intra-frame predictor 126, and the motion compensator 124 are included in the decoder portion 191.

The input of the first pass portion 110 receives an input video 111, and stores in the buffer 118 control data (e.g., motion vectors, mode selections, predicted images, and so forth) for use in the second pass portion 160.

Referring to FIG. 1B, a first input of the second pass portion 160 is connected n signal communication with an input of an entropy coder 166. The first input receives control data 162 (e.g., mode selections, and so forth) and motion vectors 164 from the first pass portion 110. A second input of the second pass portion 160 is connected in signal communication with a non-inverting input of a combiner 168. A third input of the second pass portion 160 is connected in signal communication with an input of an overlapped block motion compensation (OBMC)/deblocking module 170. The second input of the second pass portion 160 receives the input video 111, and the third input of the second pass portion receives predicted images 187 from the first pass portion 110.

An output of the combiner 168, which provides a residual 172, is connected in signal communication with an input of an atom finder 174. An output of the atom finder 174, which provides a coded residual 178, is connected in signal communication with an input of an atom coder 176 and a first non-inverting input of a combiner 180. An output of the OBMC/deblocking module 170 is connected in signal communication with an inverting input of the combiner 168 and with a second non-inverting input of the combiner 180. An output of the combiner 180, which provides an output video, is connected in signal communication with an input of a reference buffer 182. An output of the atom coder 176 is connected in signal communication with the input of the entropy coder 166. An output of the entropy coder 166 is available as an output of the second pass portion 160, and provides an output bitstream.

With respect to the second pass portion 160, the entropy coder is included in the encoder 190, and the combiner 168, the OBMC module 170, the atom finder 174, the atom coder 176, and the reference buffer 182 are included in the decoder portion 191.

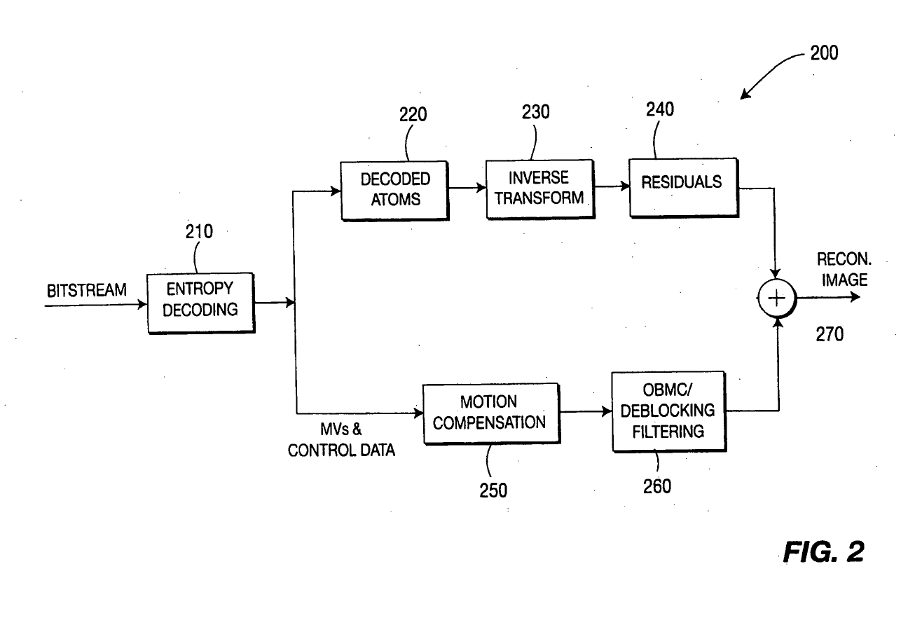

Turning to FIG. 2, an exemplary decoder in a two-pass H.264 standard-based Matching Pursuit encoder/decoder (CODEC) is indicated generally by the reference numeral 200.

An input of the decoder 200 is connected in signal communication with an input of an entropy decoder 210. An output of the entropy decoder is connected in signal communication with an input of an atom decoder 220 and an input of a motion compensator 250. An output of the inverse transform module 230, which provides residuals, is connected in signal communication with a first non-inverting input of a combiner 270. An output of the motion compensator 250 is connected in signal communication with an input of an OBMC/deblocking module 260. An output of the OBMC/deblocking module 260 is connected in signal communication with a second non-inverting input of the combiner 270. An output of the combiner is available as an output of the decoder 200.

Unlike the Matching Pursuit video codec in the prior art Gabor-based Matching Pursuit video coding approach, which is based on the H.263 codes, the present principles are applicable to the ITU-T H.264/AVC coding system. Due to the frame-based residual coding, we apply OBMC on predicted images, which is not implemented in the H.264/AVC codec.

In an embodiment in accordance with the present principles, a first pass in a video encoding scheme is compatible with the H.264 standard. There is no actual coding in the first pass. All the control data, such as, for example, mode selections, predicted images and motion vectors, are saved into a buffer for the second pass. The DCT transform is still applied in the first pass for motion compensation and mode selections using Rate Distortion Optimization (RDO). Instead of coding the residue image using DCT coefficients, all residual images are saved for the second pass. In an embodiment of the present principles, it is proposed to apply 16×16 constrained intra coding or H.264 standard compatible constrained intra coding, and treat the boundary parts between intra coded and inter coded macroblocks specially.

In the second pass, the motion vectors and control data may be coded by entropy coding. The residual images may be coded by Matching Pursuit. The atoms search and parameter coding may be performed, e.g., according to the prior art Gabor-based Matching Pursuit video coding approach. The reconstructed images are saved for reference frames.

One of the benefits of Matching Pursuit video coding is that Matching Pursuit is not block-based, so there is no blocking artifacts. However, when the motion prediction is performed on a block-basis and is inaccurate, it still originates some blocking artifacts at very low bit rates. Simulations have shown that the atoms appear at the moving contours and the areas where the motion vectors (MVs) are not very accurate. Improving the motion estimation leads the atoms to representing the residuals better.

To eliminate the artifacts from the motion prediction, one method involves using a H.264-like or improved deblocking filter to smooth the blocky boundary in a predictive image. In another approach, a smoother motion model using overlapping blocks (OBMC) is employed. In the prior art Gabor-based Matching Pursuit video coding approach, a 16×16 sine-squared window has been adopted. The N×N sine-squared window may be defined, e.g., in accordance with the prior art hybrid coding scheme. The 16×16 sine-squared window is designed for 8×8 blocks, and 16×16 blocks are treated as four 8×8 blocks.

However, in the H.264 standard, partitions with luma block size 16×16, 16×8, 8×16, and 8×8 samples are supported. In the case where partitions with 8×8 samples are chosen, the 8×8 partition is further partitioned into partitions of 8×4, 4×8 or 4×4 luma samples and corresponding chroma samples. Herein, four approaches are proposed to deal with more partition types. The first approach is to use an 8×8 sine-squared window for 4×4 partitions. For all other partitions above 4×4, divide those partitions into several 4×4 partitions. The second approach is to use a 16×16 sine-squared window for 8×8 and above partitions, but it does not touch smaller partitions than 8×8. The third approach is to use adaptive OBMC for all partitions. All of these three approaches only implement OBMC not deblocking filters, and the fourth approach is to combine OBMB with a deblocking filter(s).

Besides the redundant Gabor dictionary set in the prior art Gabor-based Matching Pursuit video coding approach, which has been implemented for residual coding, we propose utilizing more overcomplete bases. At low bit rates, the translational motion model fails to accurately represent natural motion of relevant visual features such as moving edges. Hence, most of the residual error energy is located in these areas. Thus, it is meaningful to use an edge detective redundant dictionary to represent the error images. A discrete wavelet transform (e.g., a 2-D Dual-Tree Discrete Wavelet Transform (DDWT)) having less redundancy that the 2-D Gabor dictionary may utilized, or some other edge detection dictionary may be used. The 2-D DDWT has more sub-bands/directions than the 2-D DWT. Each subband represents one direction, and it is edge detective. After noise shaping, the 2-D DDWT achieves higher PSNR with the same retained coefficients compared to the standard 2-D DWT. Thus, it is more suitable to code the edge information. After applying OBMC on the predicted images, the error images will have smoother edges. Parametric over-complete 2-D dictionaries may be used to provide smoother edges.

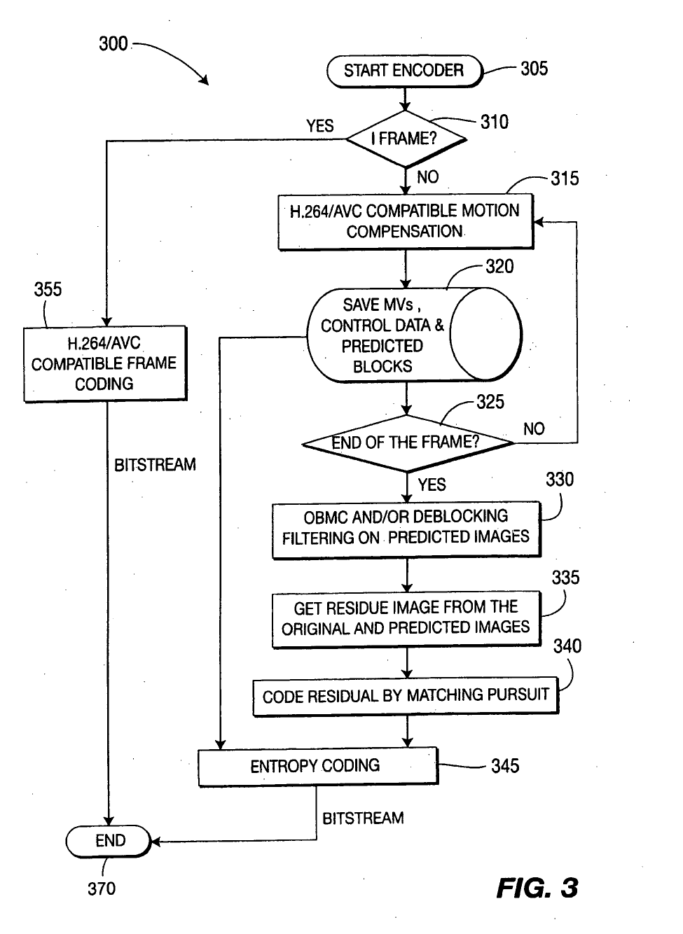

Turning to FIG. 3, an exemplary method for encoding an input Video sequence is indicated generally by the reference numeral 300. The method 300 includes a start block 305 that passes control to a decision block 310. The decision block 310 determines whether or not the current frame is an I-frame. If so, then control is passed to a function block 355. Otherwise, control is passed to a function block 315.

The function block 355 performs H.264 standard compatible frame coding to provide an output bitstream, and passes control to an end block 370.

The function block 315 performs H.264 standard compatible motion compensation, and passes control to a function block 320. The function block 320 saves the motion vectors (MVs), control data, and predicted blocks, and passes control to a decision block 325. The decision block 325 determines whether or not the end of the frame has been reached. If so, then control is passed to a function block 330. Otherwise, control is returned to the function block 315.

The function block 330 performs OBMC and/or deblocking filtering on the predicted images, and passes control to a function block 335. The function block 335 obtains a residue image from the original and predicted images, and passes control to a function block 340. The function block 340 codes a residual using Matching Pursuit, and passes control to a function block 345. The function block 345 performs entropy coding to provide an output bitstream, and passes control to the end block 370.

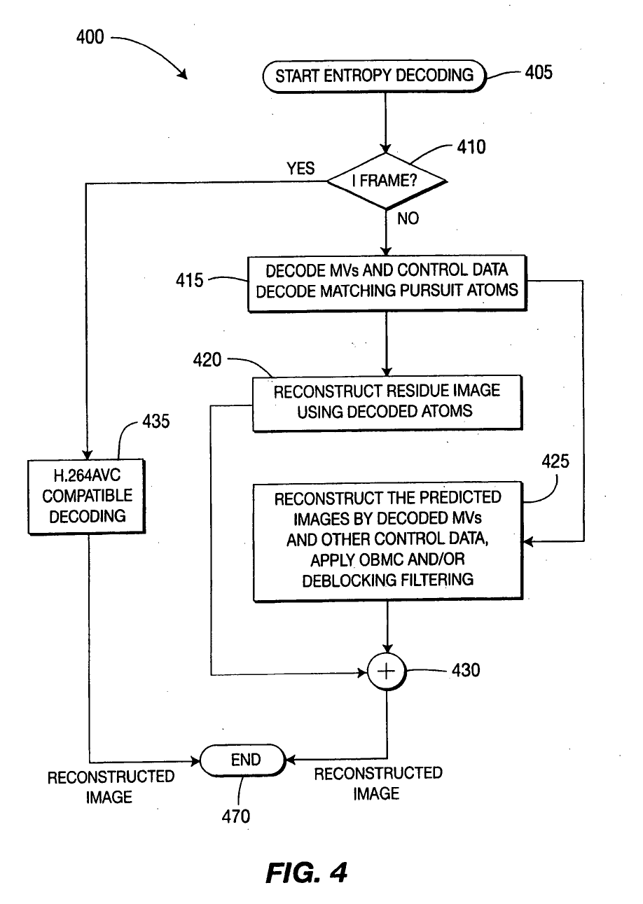

Turning to FIG. 4, an exemplary method for decoding an input video sequence is indicated generally by the reference numeral 400. The method 400 includes a start block 405 that passes control to a decision block 410. The decision block 410 determines whether or not the current frame is an I-frame. If so, then control is passed to a function block 435. Otherwise, control is passed to a function block 415.

The function block 435 performs H.264 standard compatible decoding to provide a reconstructed image, and passes control to an end block 470.

The function block 415 decodes the motion vectors, control data, and the Matching Pursuit atoms, and passes control to a function block 420 and a function block 425. The function block 420 reconstructs the residue image using decoded atoms, and passes control to a function block 430. The function block 425 reconstructs the predicted images by decoding motion vectors and other control data and applying OBMC and/or deblocking filtering, and passes control to the function block 430. The function block 430 combines the reconstructed residue image and the reconstructed predicted images to provide a reconstructed image, and passes control to the end block 470.

A description will now be given of some of the many attendant advantages/features of the present invention, some of which have been mentioned above. For example, one advantage/feature is a video encoder for encoding video signal data using a multiple-pass video encoding scheme, wherein the video encoder includes a motion estimator and a decomposition module. The motion estimator performs motion estimation on the video signal data to obtain a motion residual corresponding to the video signal data in a first encoding pass. The decomposition module, in signal communication with the motion estimator, decomposes the motion residual in a subsequent encoding pass.

Another advantage/feature is the video encoder as described above, wherein the multiple-pass video coding scheme is a two-pass video encoding scheme. The video encoder further includes a buffer, in signal communication with the motion estimator and the decomposition module, for storing the motion residual obtained in the first encoding pass for subsequent use in a second encoding pass. The decomposition module decomposes the motion residual using a redundant Gabor dictionary set in the second encoding pass.

Yet another advantage feature is the video encoder using the two-pass video encoding scheme as described above, wherein the motion estimator performs the motion estimation and coding-mode selection in compliance with the International Telecommunication Union, Telecommunication Sector (ITU-T) H.264 standard in the first encoding pass.

Still another advantage feature is the video encoder using the two-pass video encoding scheme as described above, wherein the video encoder further includes a prediction module and an overlapped block motion compensator. The prediction module, in signal communication with the buffer, forms a predicted image corresponding to the video signal data in the first encoding pass. The overlapped block motion compensator, in signal communication with the buffer, performs overlapping block motion compensation (OBMC) on the predicted image using a 16×16 sine-square window to smooth the predicted image in the second encoding pass. The buffer stores the predicted image therein in the first encoding pass for subsequent use in the second encoding pass.

Moreover, another advantage feature is the video encoder using the two-pass video encoding scheme as described above, wherein the video encoder further includes a prediction module and an overlapped block motion compensator. The prediction module, in signal communication with the buffer, forms a predicted image corresponding to the video signal data in the first encoding pass. The overlapped block motion compensator, in signal communication with the buffer, performs overlapped block motion compensation (OBMC) on only 8×8 and greater partitions of the predicted image in the second encoding pass. The buffer stores the predicted image therein in the first encoding pass for subsequent use in the second encoding pass.

Further, another advantage feature is the video encoder using the two-pass video encoding scheme as described above, wherein the video encoder further includes a prediction module and an overlapped block motion compensator. The prediction module, in signal communication with the buffer, forms a predicted image corresponding to the video signal data in the first encoding pass. The overlapped block motion compensator, in signal communication with the buffer, performs overlapping block motion compensation (OBMC) using a 8×8 sine-square window for 4×4 partitions of the predicted image in the second encoding pass. All partitions of the predicted image are divided into 4×4 partitions when OBMC is performed in the second encoding pass. The buffer stores the predicted image therein in the first encoding pass for subsequent use in the second encoding pass.

Also, another advantage feature is the video encoder using the two-pass video encoding scheme as described above, wherein the video encoder further includes a prediction module and an overlapped block motion compensator. The prediction module, in signal communication with the buffer, forms a predicted image corresponding to the video signal data in the first encoding pass. The overlapped block motion compensator, in signal communication with the buffer, performs adaptive overlapping block motion compensation (OBMC) for all partitions of the predicted image in the second encoding pass. The buffer stores the predicted image therein in the first encoding pass for subsequent use in the second encoding pass.

Additionally, another advantage feature is the video encoder using the two-pass video encoding scheme as described above, wherein the video encoder further includes a prediction module and a deblocking filter. The prediction module, in signal communication with the buffer, forms a predicted image corresponding to the video signal data in the first encoding pass. The deblocking filter, in signal communication with the buffer, performs a deblocking operation on the predicted image in the second encoding pass. The buffer stores the predicted image therein in the first encoding pass for subsequent use in the second encoding pass.

Yet another advantage feature is the video encoder using the two-pass video encoding scheme as described above, wherein the decomposition module performs a dual-tree wavelet transform to decompose the motion residual.

Still another advantage feature is the video encoder using the two-pass video encoding scheme and the dual-tree wavelet transform as described above, wherein the decomposition module uses noise shaping to select coefficients of the dual-tree wavelet transform.

Moreover, another advantage feature is the video encoder using the two-pass video encoding scheme as described above, wherein the decomposition module applies parametric over-complete 2-D dictionaries to decompose the motion residual in the second encoding pass.

Further, another advantage feature is a video decoder for decoding a video bitstream, wherein the video decoder includes an entropy decoder, an atom decoder, an inverse transformer, a motion compensator, a deblocking filter, and a combiner. The entropy decoder decodes the video bitstream to obtain a decompressed video bitstream. The atom decoder, in signal communication with the entropy decoder, decodes decompressed atoms corresponding to the decompressed bitstream to obtain decoded atoms. The inverse transformer, in signal communication with the atom decoder, applies an inverse transform to the decoded atoms to form a reconstructed residual image. The motion compensator, in signal communication with the entropy decoder, performs motion compensation using motion vectors corresponding to the decompressed bitstream to form a reconstructed predicted image. The deblocking filter, in signal communication with the motion compensator, performs deblocking filtering on the reconstructed predicted image to smooth the reconstructed predicted image. The combiner, in signal communication with the inverse transformer and the overlapped block motion compensator, combines the reconstructed predicted image and the residue image to obtain a reconstructed image.

These and other features and advantages of the present invention may be readily ascertained by one of ordinary skill in the pertinent art based on the teachings herein. It is to be understood that the teachings of the present invention may be implemented in various forms of hardware, software, firmware, special purpose processors, or combinations thereof.

Most preferably, the teachings of the present invention are implemented as a combination of hardware and software. Moreover, the software may be implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

1. A video encoder for encoding video signal data using a multiple-pass video encoding scheme, comprising:
a motion estimator for performing motion estimation on the video signal data to obtain a motion residual corresponding to the video signal data in a first encoding pass; and
a decomposition module, in signal communication with said motion estimator, for decomposing the motion residual in a subsequent encoding pass.

2. The video encoder of claim 1, wherein the multiple-pass video coding scheme is a two-pass video encoding scheme, the video encoder further comprises a buffer, in signal communication with said motion estimator and said decomposition module, for storing the motion residual obtained in the first encoding pass for subsequent use in a second encoding pass, and the decomposition module decomposes the motion residual using a redundant Gabor dictionary set in the second encoding pass.

3. The video encoder of claim 2, wherein said motion estimator performs the motion estimation and coding-mode selection in compliance with the International Telecommunication Union, Telecommunication Sector (ITU-T) H.264 standard in the first encoding pass.

4. The video encoder of claim 2, further comprising:
a prediction module, in signal communication with said buffer, for forming a predicted image corresponding to the video signal data in the first encoding pass; and
an overlapped block motion compensator, in signal communication with said buffer, for performing overlapping block motion compensation (OBMC) on the predicted image using a 16×16 sine-square window to smooth the predicted image in the second encoding pass, wherein said buffer stores the predicted image therein in the first encoding pass for subsequent use in the second encoding pass.

5. The video encoder of claim 2, further comprising:
a prediction module, in signal communication with said buffer, for forming a predicted image corresponding to the video signal data in the first encoding pass; and
an overlapped block motion compensator, in signal communication with said buffer, for performing overlapped block motion compensation (OBMC) on only 8×8 and greater partitions of the predicted image in the second encoding pass, wherein said buffer stores the predicted image therein in the first encoding pass for subsequent use in the second encoding pass.

6. The video encoder of claim 2, further comprising:
a prediction module, in signal communication with said buffer, for forming a predicted image corresponding to the video signal data in the first encoding pass; and
an overlapped block motion compensator, in signal communication with said buffer, for performing overlapping block motion compensation (OBMC) using a 8×8 sine-square window for 4×4 partitions of the predicted image in the second encoding pass, wherein all partitions of the predicted image are divided into 4×4 partitions when OBMC is performed in the second encoding pass, wherein said buffer stores the predicted image therein in the first encoding pass for subsequent use in the second encoding pass.

7. The video encoder of claim 2, further comprising:
a prediction module, in signal communication with said buffer, for forming a predicted image corresponding to the video signal data in the first encoding pass; and
an overlapped block motion compensator, in signal communication with said buffer, for performing adaptive overlapping block motion compensation (OBMC) for all partitions of the predicted image in the second encoding pass, wherein said buffer stores the predicted image therein in the first encoding pass for subsequent use in the second encoding pass.

8. The video encoder of claim 2, further comprising:
a prediction module, in signal communication with said buffer, for forming a predicted image corresponding to the video signal data in the first encoding pass; and
a deblocking filter, in signal communication with said buffer, for performing a deblocking operation on the predicted image in the second encoding pass, wherein said buffer stores the predicted image therein in the first encoding pass for subsequent use in the second encoding pass.

9. The video encoder of claim 2, wherein said decomposition module performs a dual-tree wavelet transform to decompose the motion residual.

10. The video encoder of claim 9, wherein said decomposition module uses noise shaping to select coefficients of the dual-tree wavelet transform.

11. The video encoder of claim 2, wherein said decomposition module applies parametric over-complete 2-D dictionaries to decompose the motion residual in the second encoding pass.

12. A method for encoding video signal data using a multiple-pass video encoding scheme, comprising:
performing motion estimation on the video signal data to obtain a motion residual corresponding to the video signal data in a first encoding pass; and
decomposing the motion residual in a subsequent encoding pass.

13. The method of claim 12, wherein the multiple-pass video coding scheme is a two-pass video encoding scheme, the method further comprises storing the motion residual obtained in the first encoding pass for subsequent use in a second encoding pass, and said decomposing step decomposes the motion residual using a redundant Gabor dictionary set in the second encoding pass.

14. The method of claim 13, wherein the motion estimation and coding-mode selection is performed in compliance with the International Telecommunication Union, Telecommunication Sector (ITU-T) H.264 standard in the first encoding pass.

15. The method of claim 13, further comprising:
forming a predicted image corresponding to the video signal data in the first encoding pass;
storing the predicted image in the first encoding pass; and
performing overlapping block motion compensation (OBMC) on the predicted image using a 16×16 sine-square window to smooth the predicted image in the second encoding pass.

16. The method of claim 13, further comprising:
forming a predicted image corresponding to the video signal data in the first encoding pass;
storing the predicted image in the first encoding pass; and
performing (330) overlapped block motion compensation (OBMC) on only 8×8 and greater partitions of the predicted image in the second encoding pass.

17. The method of claim 13, further comprising:
forming a predicted image corresponding to the video signal data in the first encoding pass;
storing the predicted image in the first encoding pass; and
performing overlapping block motion compensation (OBMC) using a 8×8 sine-square window for 4×4 partitions of the predicted image in the second encoding pass, wherein all partitions of the predicted image are divided into 4×4 partitions when OBMC is performed in the second encoding pass.

18. The method of claim 13, further comprising:
forming a predicted image corresponding to the video signal data in the first encoding pass;
storing the predicted image in the first encoding pass; and
performing adaptive overlapping block motion compensation (OBMC) for all partitions of the predicted image in the second encoding pass.

19. The method of claim 13, further comprising:
forming a predicted image corresponding to the video signal data in the first encoding pass;
storing the predicted image in the first encoding pass; and
performing a deblocking operation on the predicted image in the second encoding pass.

20. The method of claim 13, wherein said decomposing step performs a dual-tree wavelet transform to decompose the motion residual.

21. The method of claim 20, wherein said decomposing step uses noise shaping to select coefficients of the dual-tree wavelet transform.

22. The method of claim 13, wherein said decomposing step applies parametric over-complete 2-D dictionaries to decompose the motion residual in the second encoding pass.

23. A video decoder for decoding a video bitstream, comprising:
an entropy decoder for decoding the video bitstream to obtain a decompressed video bitstream;
an atom decoder, in signal communication with said entropy decoder, for decoding decompressed atoms corresponding to the decompressed bitstream to obtain decoded atoms;
an inverse transformer, in signal communication with said atom decoder, for applying an inverse transform to the decoded atoms to form a reconstructed residual image;
a motion compensator, in signal communication with said entropy decoder, for performing motion compensation using motion vectors corresponding to the decompressed bitstream to form a reconstructed predicted image;
a deblocking filter, in signal communication with said motion compensator, for performing deblocking filtering on the reconstructed predicted image to smooth the reconstructed predicted image; and
a combiner, in signal communication with said inverse transformer and said overlapped block motion compensator, for combining the reconstructed predicted image and the residue image to obtain a reconstructed image.

24. A method for decoding a video bitstream, comprising:
decoding the video bitstream to obtain a decompressed video bitstream;
decoding decompressed atoms corresponding to the decompressed bitstream to obtain decoded atoms;
applying an inverse transform to the decoded atoms to form a reconstructed residual image;
performing motion compensation using motion vectors corresponding to the decompressed bitstream to form a reconstructed predicted image;
performing deblocking filtering on the reconstructed predicted image to smooth the reconstructed predicted image; and
combining the reconstructed predicted image and the residue image to obtain a reconstructed image.
